(19) United States
(12) Patent Application Publication
(10) Pub. No.: US 2010/0127202 A1
(43) Pub. Date: May 27, 2010

(54) VALVE BODY

(75) Inventors: Mark S. Bors, Grafton, OH (US); William E. Patton, Columbia Station, OH (US)

Correspondence Address: CALFEE HALTER & GRISWOLD, LLP, 800 SUPERIOR AVENUE, SUITE 1400, CLEVELAND, OH, 44114, US

(73) Assignee: MOEN INCORPORATED, North Olmsted, OH (US)

(21) Appl. No.: 12/324,455

(22) Filed: Nov. 26, 2008

(51) Int. Cl. F16K 27/00

(52) U.S. Cl. 251/366

(57) ABSTRACT

A hybrid valve body is a multi-piece valve body formed of a brass component and a first non-brass component. The brass component and the first non-brass component are held together by a second non-brass component, such that the brass component and the first and second non-brass components need not be screwed together or otherwise fastened or moved against one another in a manner which could contribute to corrosion. The hybrid valve body realizes a substantial reduction in the amount of brass that would otherwise be used to form the valve body.

### FIELD

The invention relates generally to valve bodies and, more particularly, to valve bodies having a substantial portion made of a non-brass material.

### BACKGROUND

The flow of water from a water supply source to a plumbing fixture or fitting (e.g., a faucet, a tub spout, a shower head) is generally controlled by a valve member such as a valve cartridge. Manipulation of a handle connected to the valve cartridge allows a user to vary the flow rate of the water through the plumbing fixture or fitting. The valve cartridge is typically housed in a valve body that extends through and is affixed to a mounting surface, with the handle being disposed on one side of the mounting surface and connections to the water supply source being disposed on the other side of the mounting surface. The valve body has a water inlet passage through which the water from the water supply source can flow. The valve body also has a water outlet passage through which the water can be discharged to an outlet portion of the plumbing fixture or fitting. By positioning the valve cartridge between the water inlet passage and the water outlet passage, the valve cartridge can regulate the flow of water from the water inlet passage to the water outlet passage.

In one arrangement, a single valve body is used to convey the water (e.g., cold water and/or hot water) from the water source to the plumbing fixture or fitting. In another arrangement, a first valve body and a second valve body are used to convey the water (e.g., cold water and hot water, respectively) from the water source to the plumbing fixture or fitting. In these arrangements, each valve body is typically formed as an integral structure.

Conventional valve bodies have typically been made primarily, if not entirely, of brass. Brass is a metal composed primarily of copper and zinc. Since copper is the main component in brass, brass is usually classified as a copper alloy. Brass has properties that make it well suited for use in valve bodies. For example, brass is strong and hard. Furthermore, brass is easy to form into various shapes, a good conductor of heat, and generally resistant to corrosion.

Brass, however, can be relatively expensive compared to other materials that are otherwise unsuitable or undesirable for use in valve bodies. Accordingly, there is a need in the art for a valve body having a substantial portion made of a non-brass material.

### SUMMARY

A valve body assembly, according to one exemplary embodiment, includes an upper body having a first cavity; a lower body having a second cavity and including a water inlet passage and a water outlet passage in fluid communication with the second cavity; and a sleeve having a third cavity. The second cavity is operable to house a valve member (e.g., a cartridge assembly) to control the flow of water from the water inlet passage to the water outlet passage. The first cavity is operable to allow an actuating mechanism (e.g., a handle) to interface with the valve member. With at least a portion of the upper body and at least a portion of the lower body disposed in the third cavity, the sleeve is deformed to retain the upper body and the lower body in the third cavity.

At least one of the upper body, the lower body and the sleeve is not made entirely of brass. In one exemplary embodiment, the upper body and the sleeve contain no brass. In one exemplary embodiment, the upper body and the sleeve are made of aluminum. In one exemplary embodiment, the upper body and the sleeve contain no brass and the lower body includes a brass content but is not made entirely of brass. In one exemplary embodiment, a portion of the lower body is made of a plastic.

In one exemplary embodiment, between 15% and 50% by volume of the valve body assembly is brass. In one exemplary embodiment, between 45% and 80% by weight of the valve body assembly is brass.

In one exemplary embodiment, between 35% and 45% by volume of the valve body assembly is brass. In one exemplary embodiment, approximately 40.2% by volume of the valve body assembly is brass.

In one exemplary embodiment, between 20% and 30% by volume of the valve body assembly is brass. In one exemplary embodiment, approximately 24.7% by volume of the valve body assembly is brass.

In one exemplary embodiment, between 62% and 72% by weight of the valve body assembly is brass. In one exemplary embodiment, approximately 67.3% by weight of the valve body assembly is brass.

In one exemplary embodiment, between 51% and 61% by weight of the valve body assembly is brass. In one exemplary embodiment, approximately 55.6% by weight of the valve body assembly is brass.

In one exemplary embodiment, the valve body assembly realizes a reduction between 50% and 80% by volume in brass as compared to a similar valve body assembly made entirely of brass. In one exemplary embodiment, the valve body assembly realizes a reduction between 57% and 67% by volume in brass as compared to a similar valve body assembly made entirely of brass. In one exemplary embodiment, the valve body assembly realizes a reduction of approximately 61.5% by volume in brass as compared to a similar valve body assembly made entirely of brass. In one exemplary embodiment, the valve body assembly realizes a reduction between 62% and 72% by volume in brass as compared to a similar valve body assembly made entirely of brass. In one exemplary embodiment, the valve body assembly realizes a reduction of approximately 67.4% by volume in brass as compared to a similar valve body assembly made entirely of brass.

In one exemplary embodiment, the valve body assembly realizes a reduction between 50% and 80% by weight in brass as compared to a similar valve body assembly made entirely of brass. In one exemplary embodiment, the valve body assembly realizes a reduction between 55% and 65% by weight in brass as compared to a similar valve body assembly made entirely of brass. In one exemplary embodiment, the valve body assembly realizes a reduction of approximately 60.0% by weight in brass as compared to a similar valve body assembly made entirely of brass. In one exemplary embodiment, the valve body assembly realizes a reduction between 62% and 72% by weight in brass as compared to a similar valve body assembly made entirely of brass. In one exemplary embodiment, the valve body assembly realizes a reduction of approximately 66.9% by weight in brass as compared to a similar valve body assembly made entirely of brass.

In one exemplary embodiment, the valve body assembly includes brass and non-brass material. The valve body assembly has a brass content measured as a volume of brass in the valve body assembly and a non-brass content measured as a volume of non-brass material in the valve body assembly, and a ratio of the brass content to the non-brass content is less than or equal to 0.673. In one exemplary embodiment, the valve body assembly has a brass content measured as a volume of brass in the valve body assembly and a non-brass content measured as a volume of non-brass material in the valve body assembly, and a ratio of the brass content to the non-brass content is less than or equal to 0.327.

In one exemplary embodiment, the valve body assembly includes brass and non-brass material. The valve body assembly has a brass content measured as a weight of brass in the valve body assembly and a non-brass content measured as a weight of non-brass material in the valve body assembly, and a ratio of the brass content to the non-brass content is less than or equal to 2.058. In one exemplary embodiment, the valve body assembly has a brass content measured as a weight of brass in the valve body assembly and a non-brass content measured as a weight of non-brass material in the valve body assembly, and a ratio of the brass content to the non-brass content is less than or equal to 1.250.

In one exemplary embodiment, the valve body assembly includes brass and non-brass material. The valve body assembly has a brass content measured as a volume of brass in the valve body assembly and a non-brass content measured as a volume of non-brass material in the valve body assembly, and the brass content is less than the non-brass content.

A valve body assembly, according to one exemplary embodiment, is a three-piece valve body that includes a first member, a second member and a third member. The second member includes a water inlet passage and a water outlet passage that form a water flow path through the valve body. The second member also includes a cavity formed between the water inlet passage and the water outlet passage, the cavity being operable to receive a valve member (e.g., a cartridge assembly) for controlling the flow rate of water along the water flow path. The first member includes an opening that is operable to allow an actuating member (e.g., a handle) to interface with a valve member in the cavity of the second member. The third member includes a cavity that is operable to house at least a portion of the first member and at least a portion of the second member therein, such that deformation of the third member prevents axial displacement of the first member relative to the second member.

At least one of the first member, the second member and the third member is not made entirely of brass. In one exemplary embodiment, the first member and the third member contain no brass. In one exemplary embodiment, the first member and the third member are made of aluminum. In one exemplary embodiment, the first member and the third member contain no brass and the second member includes a brass content but is not made entirely of brass. In one exemplary embodiment, a portion of the second member is made of a plastic.

In one exemplary embodiment, between 15% and 50% by volume of the three-piece valve body is brass. In one exemplary embodiment, between 45% and 80% by weight of the three-piece valve body is brass.

In one exemplary embodiment, between 35% and 45% by volume of the three-piece valve body is brass. In one exemplary embodiment, approximately 40.2% by volume of the three-piece valve body is brass.

In one exemplary embodiment, between 20% and 30% by volume of the three-piece valve body is brass. In one exemplary embodiment, approximately 24.7% by volume of the three-piece valve body is brass.

In one exemplary embodiment, between 62% and 72% by weight of the valve body assembly is brass. In one exemplary embodiment, approximately 67.3% by weight of the three-piece valve body is brass.

In one exemplary embodiment, between 51% and 61% by weight of the valve body assembly is brass. In one exemplary embodiment, approximately 55.6% by weight of the three-piece valve body is brass.

In one exemplary embodiment, the three-piece valve body realizes a reduction between 50% and 80% by volume in brass as compared to a similar valve body made entirely of brass. In one exemplary embodiment, the valve body assembly realizes a reduction between 57% and 67% by volume in brass as compared to a similar valve body assembly made entirely of brass. In one exemplary embodiment, the three-piece valve body realizes a reduction of approximately 61.5% by volume in brass as compared to a similar valve body made entirely of brass. In one exemplary embodiment, the valve body assembly realizes a reduction between 62% and 72% by volume in brass as compared to a similar valve body assembly made entirely of brass. In one exemplary embodiment, the three-piece valve body realizes a reduction of approximately 67.4% by volume in brass as compared to a similar valve body made entirely of brass.

In one exemplary embodiment, the three-piece valve body realizes a reduction between 50% and 80% by weight in brass as compared to a similar valve body made entirely of brass. In one exemplary embodiment, the valve body assembly realizes a reduction between 55% and 65% by weight in brass as compared to a similar valve body assembly made entirely of brass. In one exemplary embodiment, the three-piece valve body realizes a reduction of approximately 60.0% by weight in brass as compared to a similar valve body made entirely of brass. In one exemplary embodiment, the valve body assembly realizes a reduction between 62% and 72% by weight in brass as compared to a similar valve body assembly made entirely of brass. In one exemplary embodiment, the three-piece valve body realizes a reduction of approximately 66.9% by weight in brass as compared to a similar valve body made entirely of brass.

In one exemplary embodiment, the three-piece valve body includes brass and non-brass material. In one exemplary embodiment, the three-piece valve body has a brass content measured as a volume of brass in the three-piece valve body and a non-brass content measured as a volume of non-brass material in the three-piece valve body, and a ratio of the brass content to the non-brass content is less than or equal to 0.673. In one exemplary embodiment, the three-piece valve body has a brass content measured as a volume of brass in the three-piece valve body and a non-brass content measured as a volume of non-brass material in the three-piece valve body, and a ratio of the brass content to the non-brass content is less than or equal to 0.327.

In one exemplary embodiment, the three-piece valve body includes brass and non-brass material. In one exemplary embodiment, the three-piece valve body has a brass content measured as a weight of brass in the three-piece valve body and a non-brass content measured as a weight of non-brass material in the three-piece valve body, and a ratio of the brass content to the non-brass content is less than or equal to 2.058. In one exemplary embodiment, the three-piece valve body has a brass content measured as a weight of brass in the three-piece valve body and a non-brass content measured as a weight of non-brass material in the three-piece valve body, and a ratio of the brass content to the non-brass content is less than or equal to 1.250.

In one exemplary embodiment, the three-piece valve body includes brass and non-brass material. In one exemplary embodiment, the three-piece valve body has a brass content measured as a volume of brass in the three-piece valve body and a non-brass content measured as a volume of non-brass material in the three-piece valve body, and the brass content is less than the non-brass content.

Numerous advantages and features will become readily apparent from the following detailed description of exemplary embodiments, from the claims and from the accompanying drawings.

### BRIEF DESCRIPTION OF THE DRAWINGS

The invention as well as embodiments and advantages thereof are described below in greater detail, by way of example, with reference to the drawings in which:

FIGS. 1A-1F show a valve body assembly, according to a first exemplary embodiment. FIG. 1A is a perspective view of the valve body assembly. FIG. 1B is an exploded perspective view of the valve body assembly. FIG. 1C is a side elevational view of the valve body assembly. FIG. 1D is a side elevational view of the valve body assembly, with the valve body assembly rotated 90 degrees relative to the view shown in FIG. 1C. FIG. 1E is a bottom plan view of the valve body assembly. FIG. 1F is s cross-sectional view of the valve body assembly of FIG. 1E, along line A-A.

FIGS. 2A-2D show an exemplary sleeve used in the exemplary valve body assembly of FIGS. 1A-1F. FIG. 2A is a perspective view of the sleeve. FIG. 2B is a top plan view of the sleeve. FIG. 2C is a bottom plan view of the sleeve. FIG. 2D is a cross-sectional view of the sleeve of FIG. 2C, along line A-A.

FIGS. 3A-3D show an exemplary upper body used in the exemplary valve body assembly of FIGS. 1A-1F. FIG. 3A is a perspective view of the upper body. FIG. 3B is a side elevational view of the upper body. FIG. 3C is a top plan view of the upper body. FIG. 3D is a cross-sectional view of the upper body of FIG. 3C, along line A-A.

FIGS. 4A-4D show an exemplary lower body used in the exemplary valve body assembly of FIGS. 1A-1F. FIG. 4A is a perspective view of the lower body. FIG. 4B is an exploded perspective view of the lower body. FIG. 4C is a side elevational view of the lower body. FIG. 4D is a cross-sectional view of the lower body of FIG. 4C, along line A-A.

FIGS. 5A-5G show a valve body assembly, according to a second exemplary embodiment. FIG. 5A is a perspective view of the valve body assembly. FIG. 5B is an exploded perspective view of the valve body assembly, including an exploded perspective view of a lower body of the valve body assembly. FIG. 5C is a side elevational view of the valve body assembly. FIG. 5D is a side elevational view of the valve body assembly, with the valve body assembly rotated 90 degrees relative to the view shown in FIG. 5C. FIG. 5E is a top plan view of the valve body assembly. FIG. 5F is a bottom plan view of the valve body assembly. FIG. 5G is a cross-sectional view of the valve body assembly of FIG. 5E, along line A-A.

### DETAILED DESCRIPTION

While the general inventive concept is susceptible of embodiment in many different forms, there are shown in the drawings and will be described herein in detail specific embodiments thereof with the understanding that the present disclosure is to be considered as an exemplification of the principles of the general inventive concept. Accordingly, the general inventive concept is not intended to be limited to the specific embodiments illustrated herein.

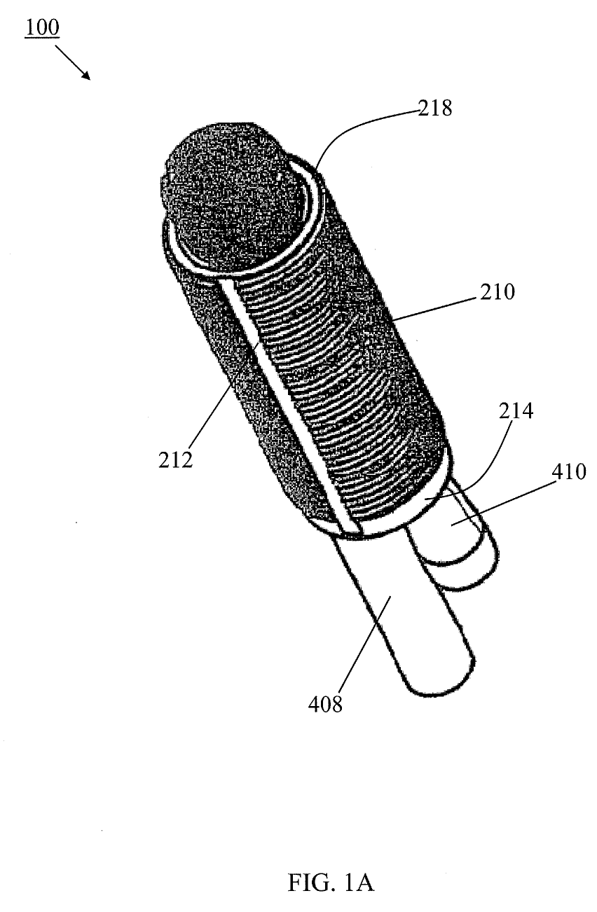

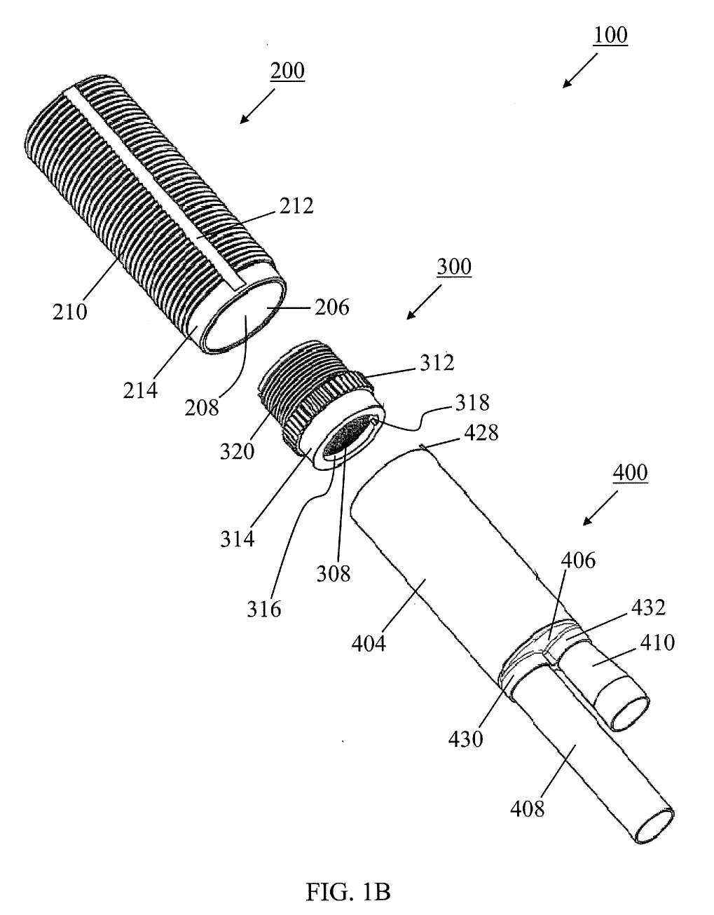

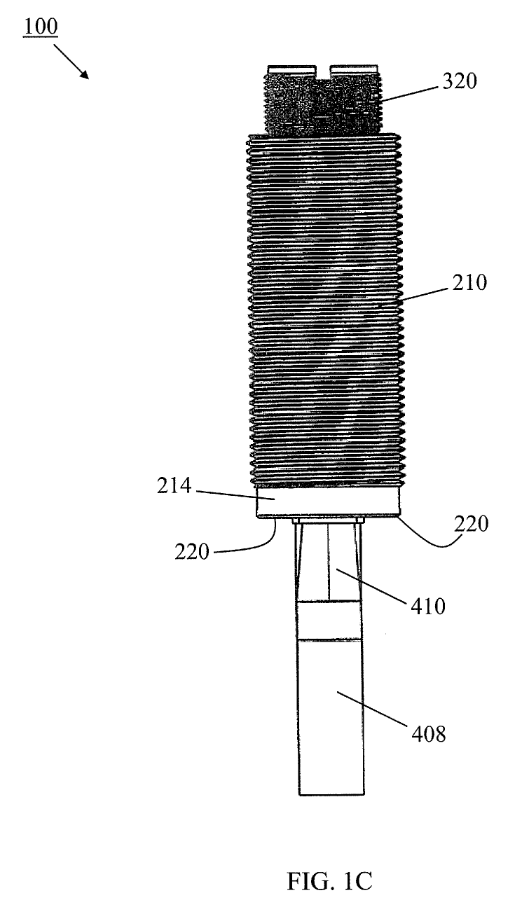

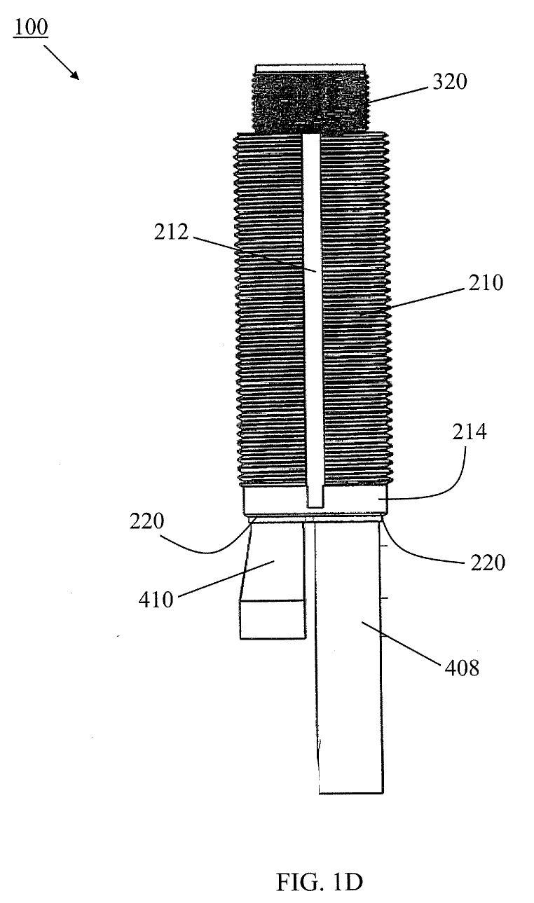

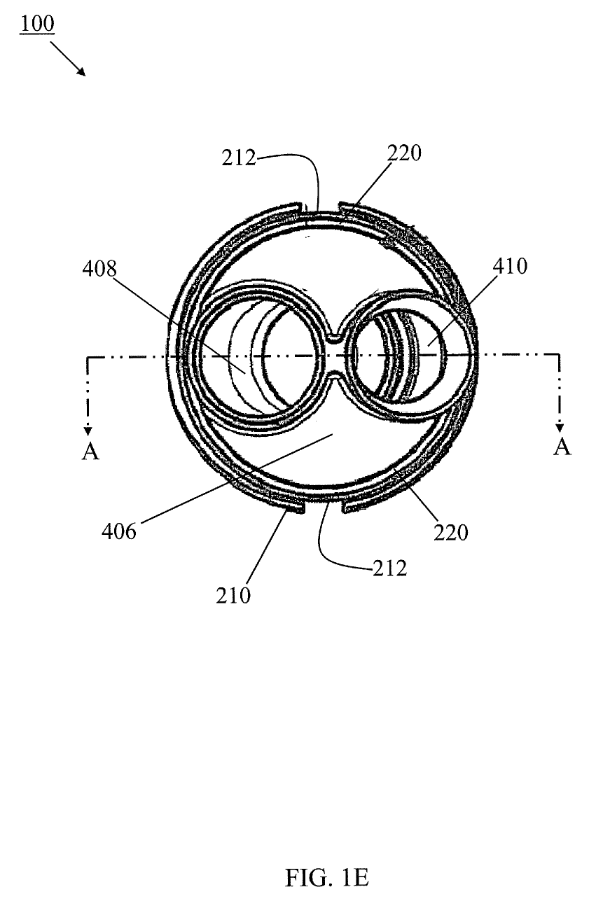

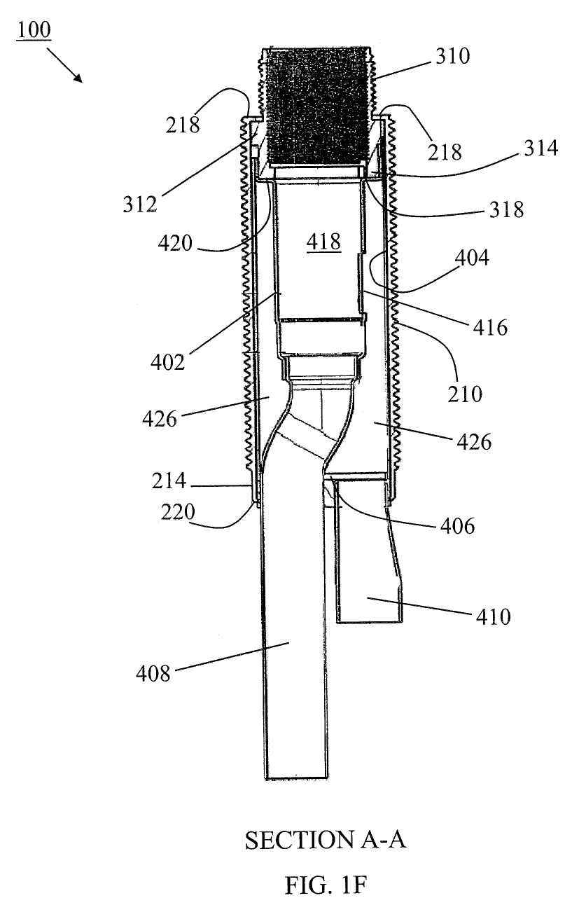

Referring to FIGS. 1A-1F, a hybrid valve body, according to a first exemplary embodiment, is shown as a multi-piece valve body assembly 100. The valve body assembly 100 includes a sleeve 200, an upper body 300 and a lower body 400, which are discrete components (see FIG. 1B).

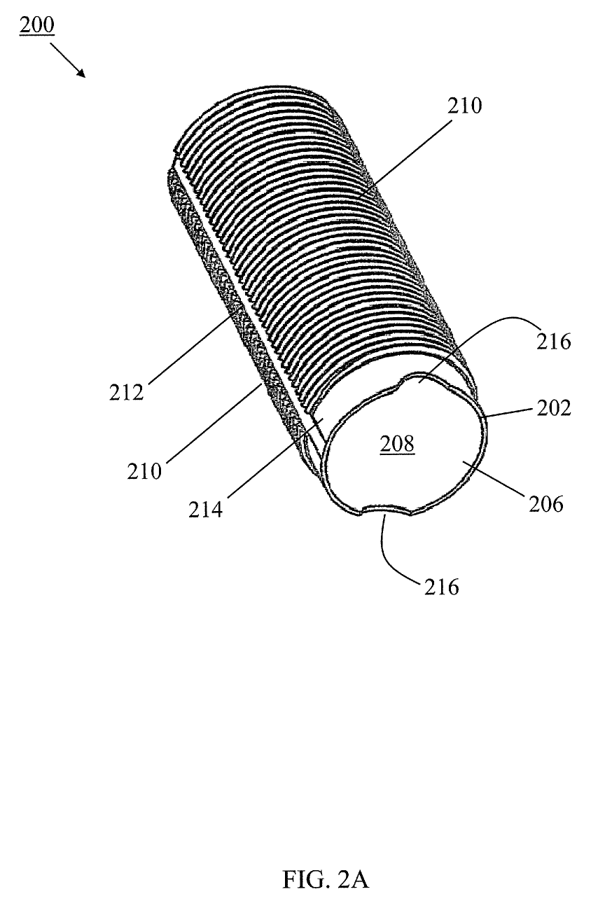

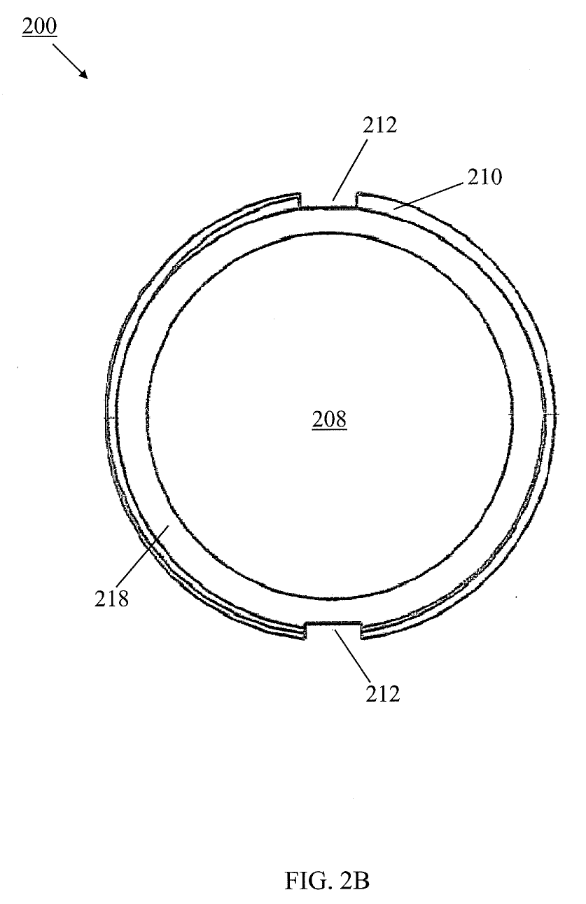

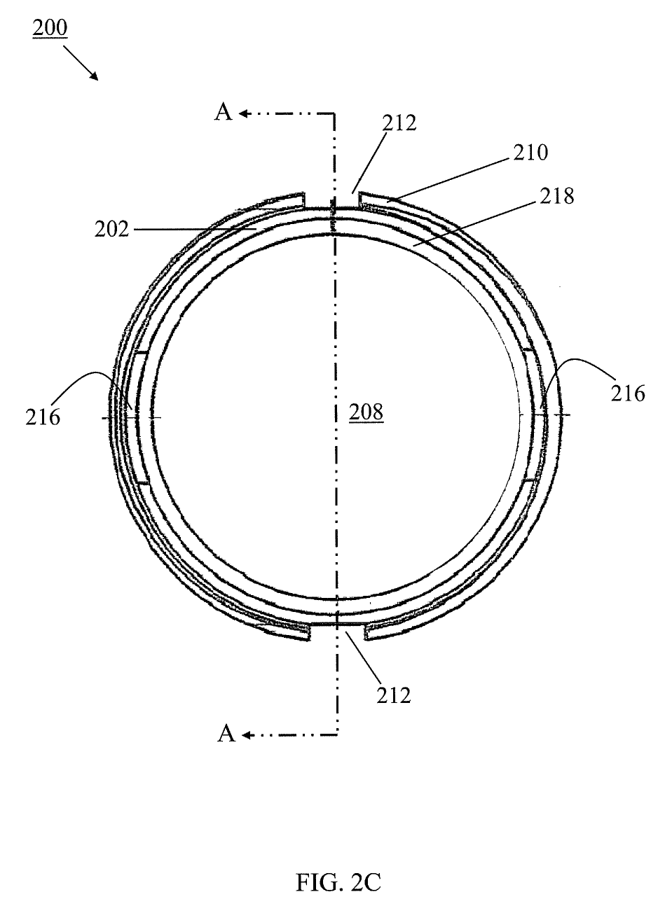

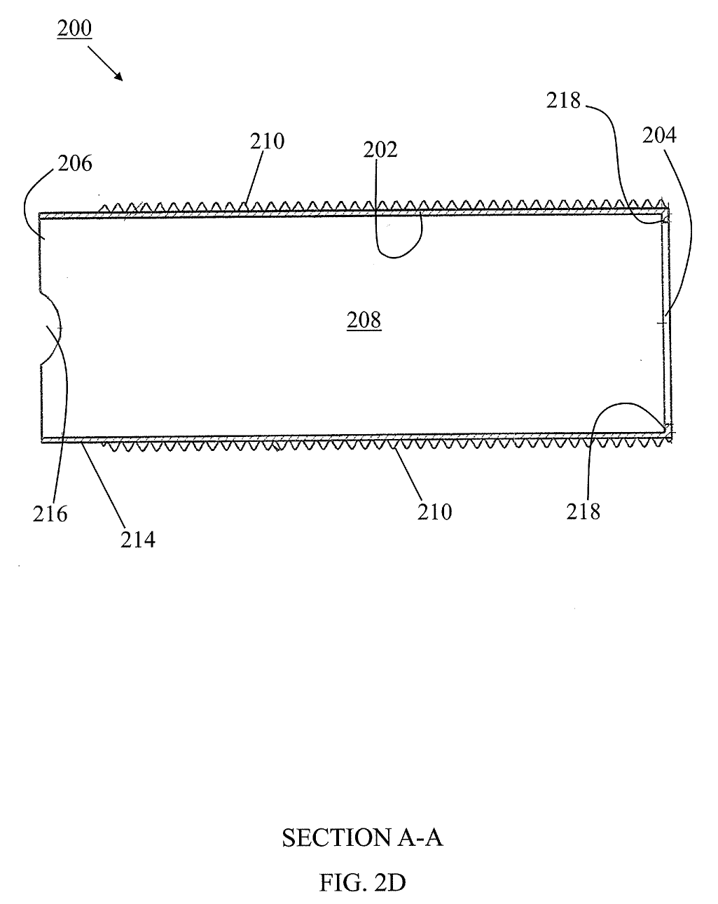

As shown in FIGS. 2A-2D, the sleeve 200 is a generally tubular body 202. The tubular body 202 has a generally circular upper opening 204 and a generally circular lower opening 206 (see FIG. 2D). The tubular body 202 is hollow and includes a generally cylindrical cavity 208 that extends between the upper opening 204 and the lower opening 206.

Threads 210 are formed along a length of an outer surface of the tubular body 202 (see FIGS. 2A and 2D). In one exemplary embodiment, one or more lengthwise non-threaded portions or grooves 212 are formed on the outer surface of the tubular body 202 (see FIGS. 2A-2C).

A portion of the tubular body 202 is a lip portion 214 on which the threads 210 are not formed (see FIGS. 2A and 2D). A pair of curved notches 216 are formed in the lip portion 214, such that the notches 216 are aligned across from one another (see FIGS. 2A and 2C-2D).

The tubular body 202 also includes a generally circular ledge 218 that defines the upper opening 204, whereas the lip portion 214 defines the lower opening 206 (see FIGS. 2A-2B and 2D). A diameter of the upper opening 204 is smaller than a diameter of the lower opening 206 (see FIGS. 2A and 2C-2D).

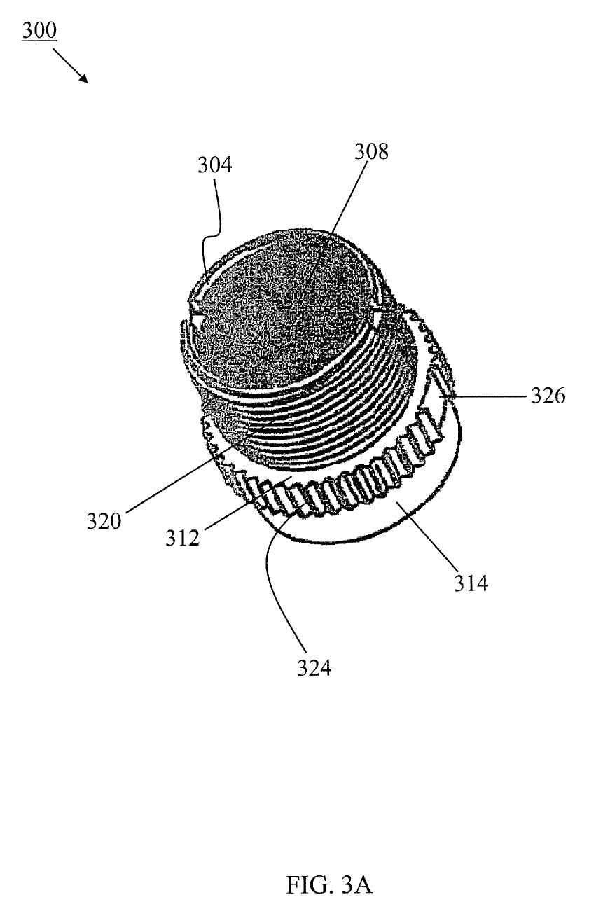

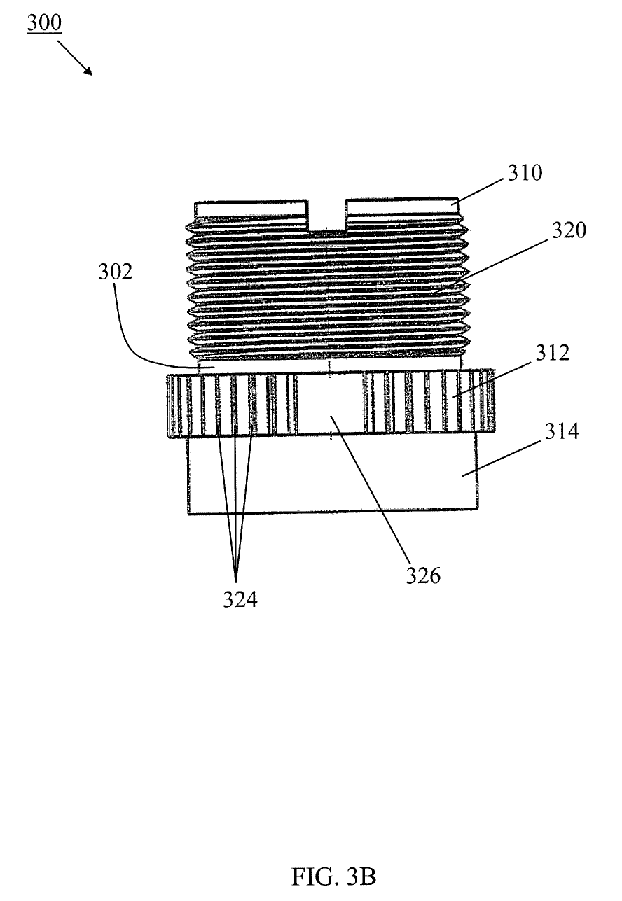

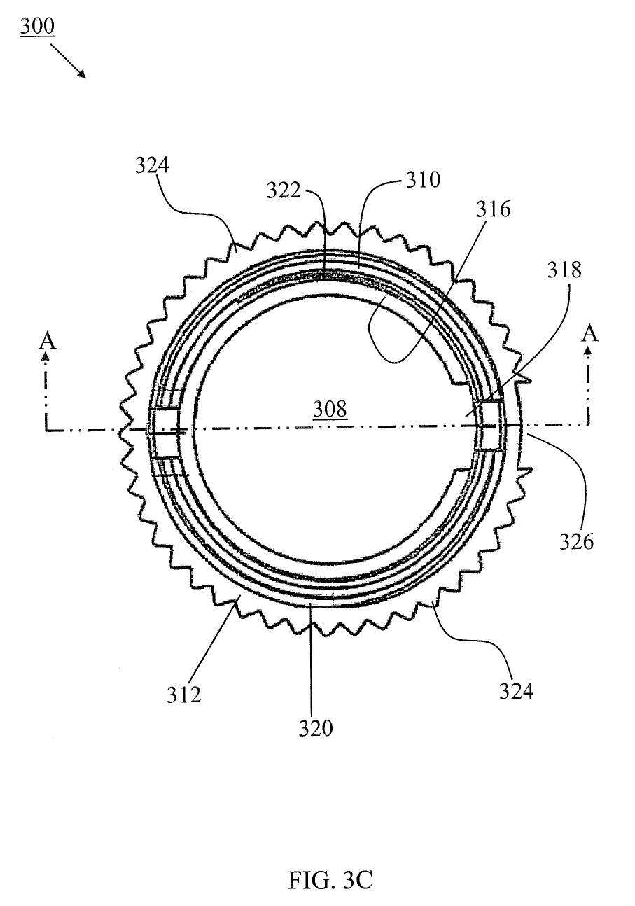

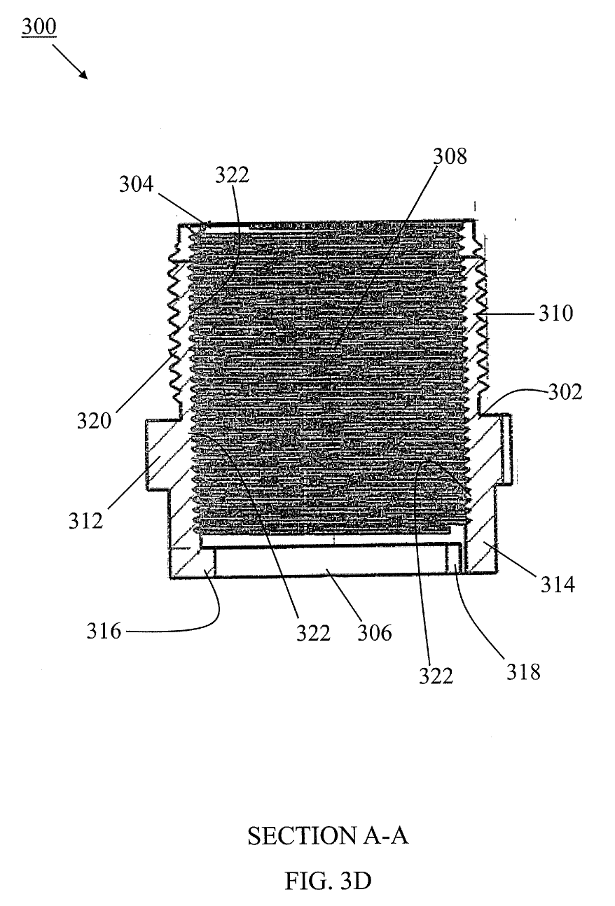

As shown in FIGS. 3A-3D, the upper body 300 is a generally tubular body 302. The tubular body 302 has a generally circular upper opening 304 and a generally circular lower opening 306 (see FIGS. 3A and 3D). The tubular body 302 is hollow and includes a generally cylindrical cavity 308 that extends between the upper opening 304 and the lower opening 306 (see FIGS. 1B and 3C-3D).

The tubular body 302 includes an upper portion 310, a middle portion 312 and a lower portion 314 (see FIGS. 1B, 3A-3B and 3D). The upper opening 304 is formed in the upper portion 310 (see FIGS. 3A and 3D). The lower portion 314 includes a ledge 316 that defines the lower opening 306 (see FIGS. 3C-3D). A groove or keyway 318 is formed in the ledge 316 (see FIGS. 1B and 3C-3D).

The middle portion 312 is formed between the upper portion 310 and the lower portion 314. A largest diameter of the middle portion 312 is greater than a largest diameter of the upper portion 310 and a largest diameter of the lower portion 314. The largest diameter of the lower portion 314 is greater than the largest diameter of the upper portion 310.

Outer threads 320 are formed on an outer surface of the upper portion 310 (see FIGS. 3A-3D). Inner threads 322 are formed on an inner surface of the upper portion 310, an inner surface of the middle portion 312 and an inner surface of the lower portion 314 (see FIGS. 3A and 3C-3D).

An outer circumference of the middle portion 312 includes a series of adjacent longitudinal teeth 324 (see FIGS. 3A-3C). A portion of the outer circumference of the middle portion 312 is lacking any of the teeth 324, thereby forming a gap 326 in the series of teeth 324. The gap 326 on the middle portion 312 is aligned with the groove 318 in the ledge 316 of the lower portion 314 (see FIG. 3C).

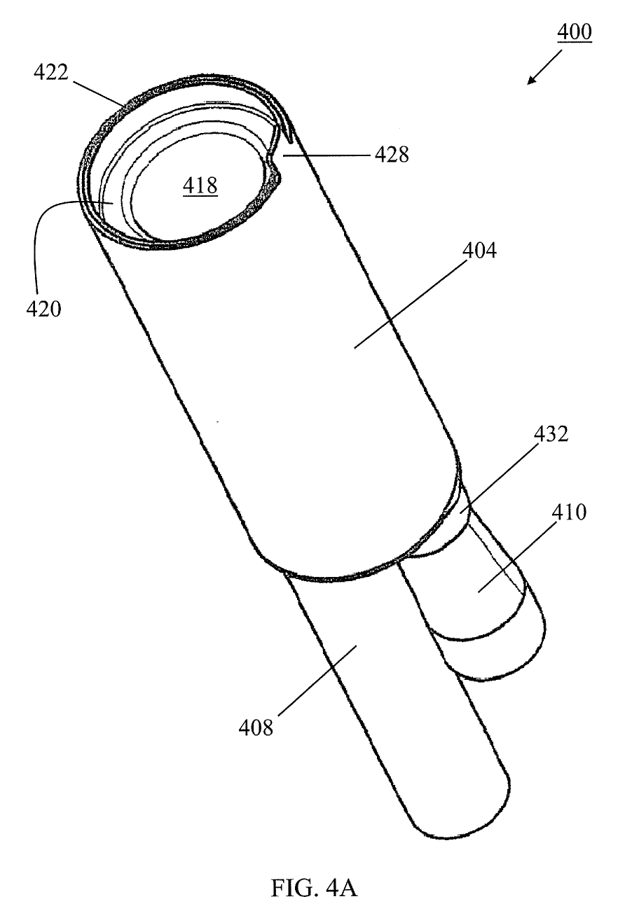

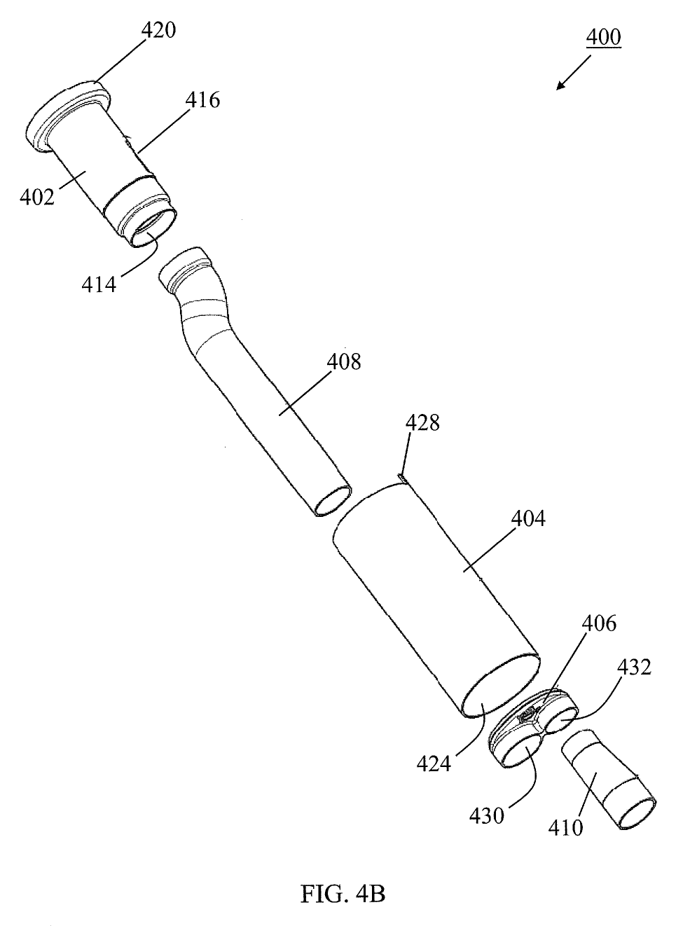

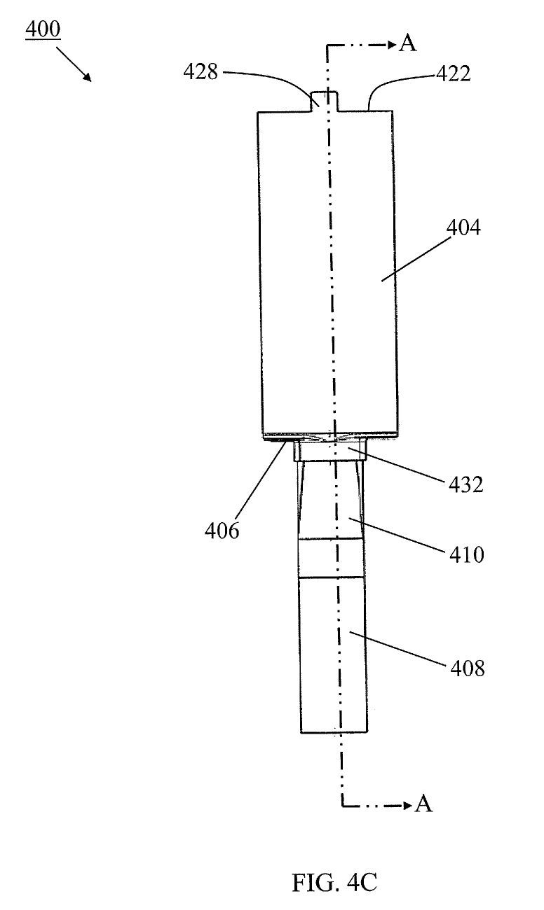

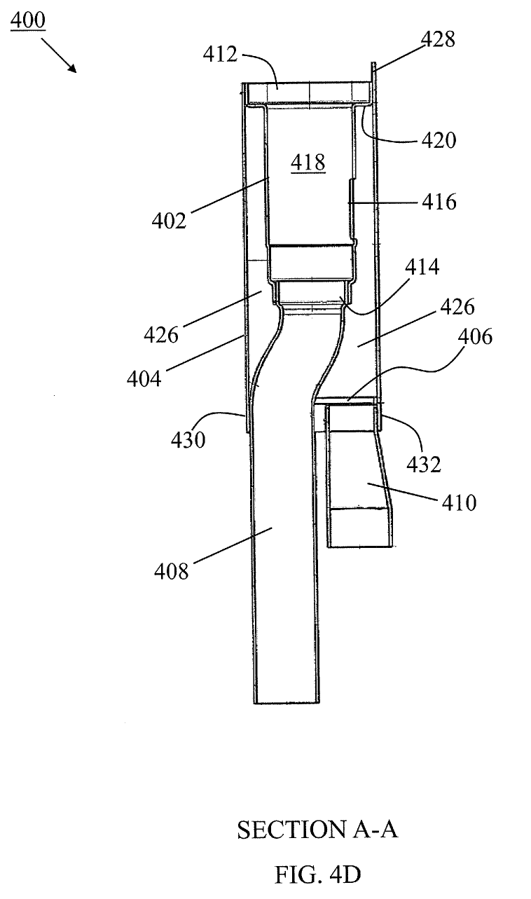

As shown in FIGS. 4A-4D, the lower body 400 is an assembly including a number of components that are joined together to form an integral structure. In one exemplary embodiment, the components are joined together by brazing. More specifically, the lower body 400 includes a valve receptacle 402, a shell 404, a cover 406, an inlet conduit 408 and an outlet conduit 410 (see FIGS. 4B and 4D).

The valve receptacle 402 is a generally tubular body having a generally circular upper opening 412, a generally circular lower opening 414 and a side opening 416. The valve receptacle 402 is hollow and includes a generally cylindrical cavity 418 that extends between the upper opening 412 and the lower opening 414. A diameter of the valve receptacle 402 increases near the upper opening 412 to form an annular flange 420.

The shell 404 is a generally tubular body having a generally circular upper opening 422 and a generally circular lower opening 424 (see FIGS. 4A-4B). The shell 404 is hollow and includes a generally cylindrical cavity 426 that extends between the upper opening 422 and the lower opening 424 (see FIGS. 4A-4B and 4D). A tab 428 is formed on the shell 404 and extends beyond the upper opening 422 (see FIGS. 4A-4D).

The cover 406 is a generally disc-shaped body having a pair of apertures formed therein (see FIGS. 4B and 4D). The apertures form an inlet port 430 and an outlet port 432 through the cover 406. The cover 406 is sized to close the lower opening 424 of the shell 404. The inlet conduit 408 extends through the inlet port 430 of the cover 406 such that one end of the inlet conduit 408 interfaces with the lower opening 414 of the valve receptacle 402 and the other end of the inlet conduit 408 is located outside the shell 404 for connection to a water supply source (not shown). The outlet conduit 410 interfaces with the outlet port 432 such that at least a portion of the outlet conduit 410 is located outside the shell 404 for connection to a plumbing fixture or fitting (not shown).

The valve body assembly 100 is assembled by inserting the upper body 300 through the lower opening 206 of the sleeve 200. The upper body 300 is then slid through the cavity 208 of the sleeve 200 toward the upper opening 204 of the sleeve 200. The upper portion 310 of the upper body 300 is sized to fit through the upper opening 204 of the sleeve 200, while the middle portion 312 of the upper body 300 is sized so that it does not fit through the upper opening 204 of the sleeve 200 (see FIG. 1F). In this manner, an upper surface of the middle portion 312 of the upper body 300 abuts a lower surface of the ledge 218 of the sleeve 200 (see FIG. 1F). Accordingly, the upper portion 310 of the upper body 300 projects out of the sleeve 200, while the middle portion 312 and lower portion 314 of the upper body 300 are located in the cavity 208 of the sleeve 200.

Thereafter, the lower body 400 is inserted through the lower opening 206 of the sleeve 200. The lower body 400 is then slid through the cavity 208 of the sleeve 200 toward the upper body 300. The lower body 400 is positioned in the cavity 208 of the sleeve 200 so that the lower body 400 interfaces with the upper body 300 within the sleeve 200 (see FIG. 1F). At least a portion of the lower portion 314 of the upper body 300 is received in the annular flange 420 of the valve receptacle 402 of the lower body 400. For example, the groove 318 in the ledge 316 of the lower portion 314 of the upper body 300 is positioned in the annular flange 420 of the valve receptacle 402 of the lower body 400, during assembly of the valve body assembly 100.

The tab 428 on the shell 404 of the lower body 400 fits into the gap 326 on the middle portion 312 of the upper body 300 (see FIG. 1F). The tab 428 and the gap 326 interface to ensure proper alignment of the upper body 300 relative to the lower body 400. For example, the tab 428 and the gap 326 interface to align the groove 318 of the upper body 300 with the side opening 416 of the lower body 400. By interfacing, the tab 428 and the gap 326 also prevent rotation of the upper body 300 independently of the lower body 400. Further still, since the upper body 300 is fixed relative to the sleeve 200, as described below, the interface between the tab 428 and the gap 326 prevents rotation of the lower body 400 relative to the sleeve 200.

Once the upper body 300 and the lower body 400 are inserted into the sleeve 200, the lip portion 214 of the sleeve 200 is deformed to secure the upper body 300 and the lower body 400 in the sleeve 200. Specifically, a portion 220 of the lip portion 214 is rolled over a portion of a lower surface of the cover 406 of the lower body 400 (see FIGS. 1C-1F). The notches 216 in the lip portion 214 prevent the inlet port 430 and the outlet port 432 of the cover 406 from being damaged by the portion 220 of the lip portion 214 being rolled over the cover 406. In this manner, the upper body 300 and the lower body 400 are secured in the sleeve 200 between the ledge 218 and the portion 220 of the lip portion 214 (see FIG. 1F).

In one exemplary embodiment, the sleeve 200 is further deformed during assembly of the valve body assembly 100. Specifically, indents (not shown) are formed in the grooves 212 near the upper opening 204 of the sleeve 200. The indents project into the cavity 208 of the sleeve 200 and are positioned in spaces between the teeth 324 of the middle portion 312 of the upper body 300, thereby preventing rotation of the upper body 300 relative to the sleeve 200.

After assembly, the valve body assembly 100 can be installed by extending the valve body assembly 100 through a hole in a mounting surface. The grooves 212 on the valve body assembly 100 can interface with a mounting bracket to prevent rotation of the valve body assembly 100 relative to the mounting surface. A first retention nut can engage the outer threads 320 on the valve body assembly 100 on a first side of the mounting surface and a second retention nut can engage the threads 210 on the valve body assembly 100 on a second side of the mounting surface to secure the valve body assembly 100 to the mounting surface.

A first hose can connect the inlet conduit 408 of the valve body assembly 100 to the water supply source. A second hose can connect the outlet conduit 410 of the valve body assembly 100 to the plumbing fixture or fitting. The water inlet conduit 408, the valve receptacle 402, the side opening 416, the cavity 426 and the water outlet conduit 410 define a water flow path through the valve body assembly 100 (see FIG. 1F).

A valve member or cartridge can be placed in the valve receptacle 402 of the valve body assembly 100 to allow a user to control the flow rate of water from the water supply source, through the water flow path of the valve body assembly 100, to the plumbing fixture or fitting. The valve cartridge can include a projection or key sized to fit into the groove 318 of the upper body 300 to properly position the valve cartridge within the valve body assembly 100, thereby aligning the valve cartridge relative to the side opening 416 of the valve receptacle 402. A third retention nut can engage the inner threads 322 of the upper body 300 to secure the valve cartridge in the cavity 418 of the valve receptacle 402.

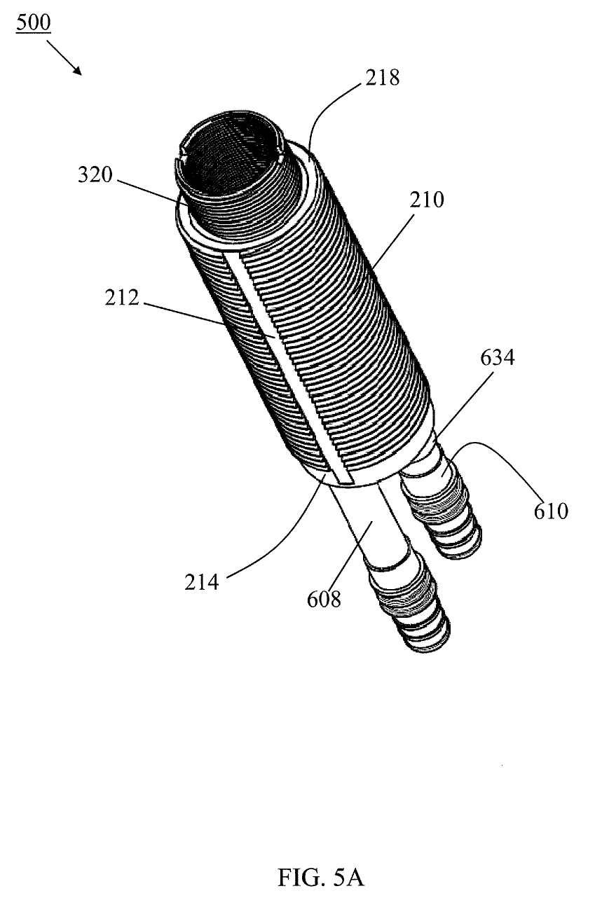

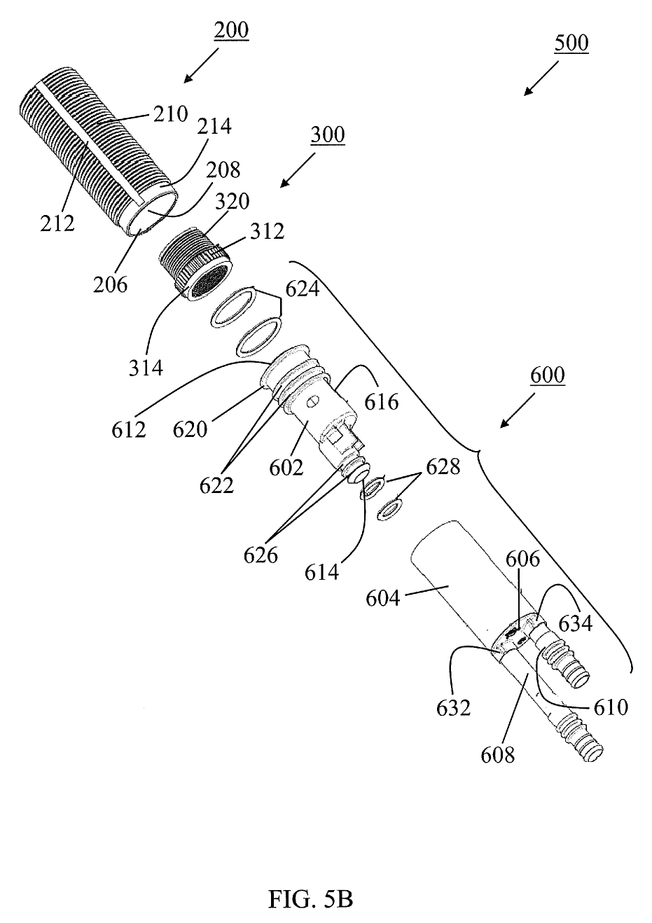

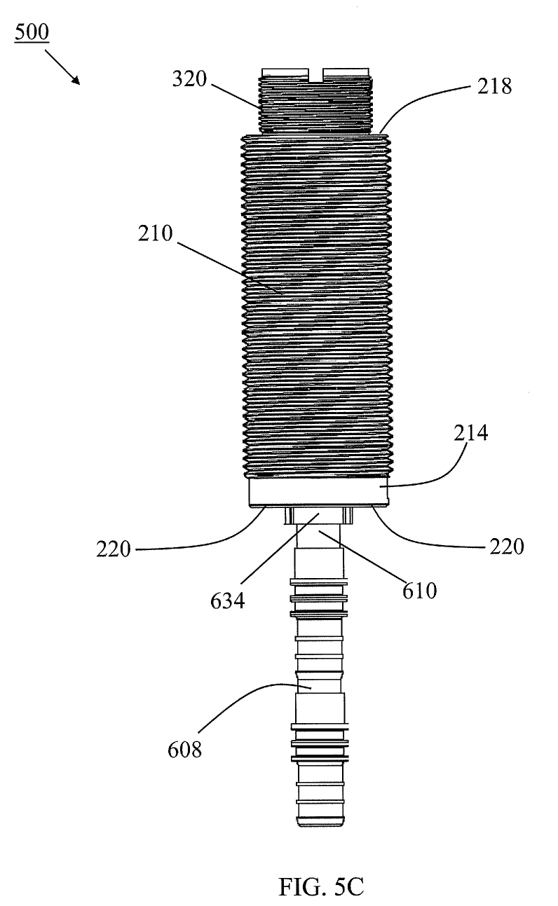

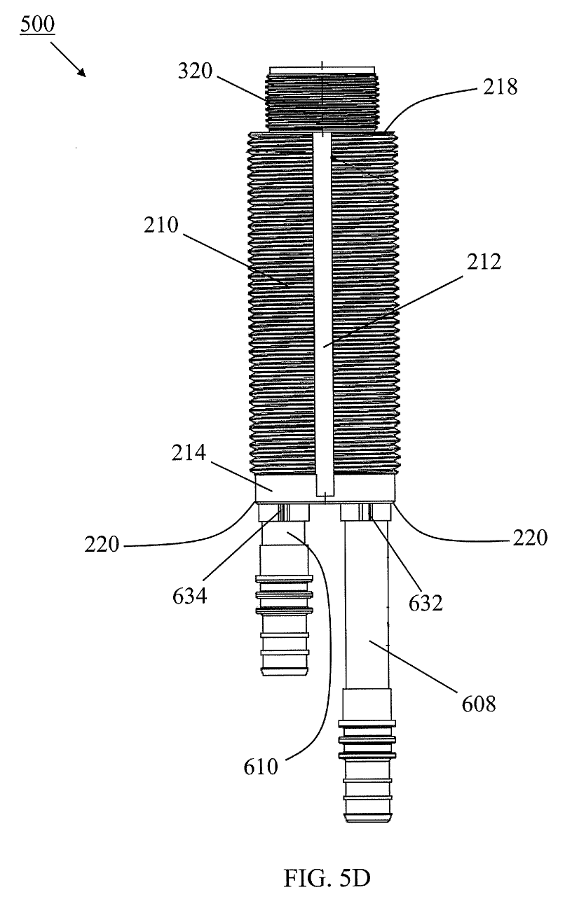

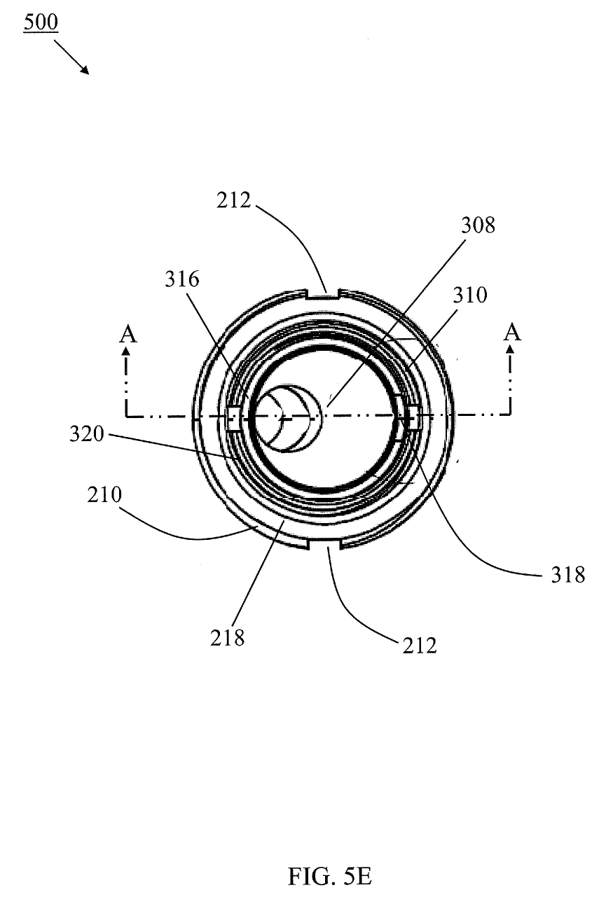

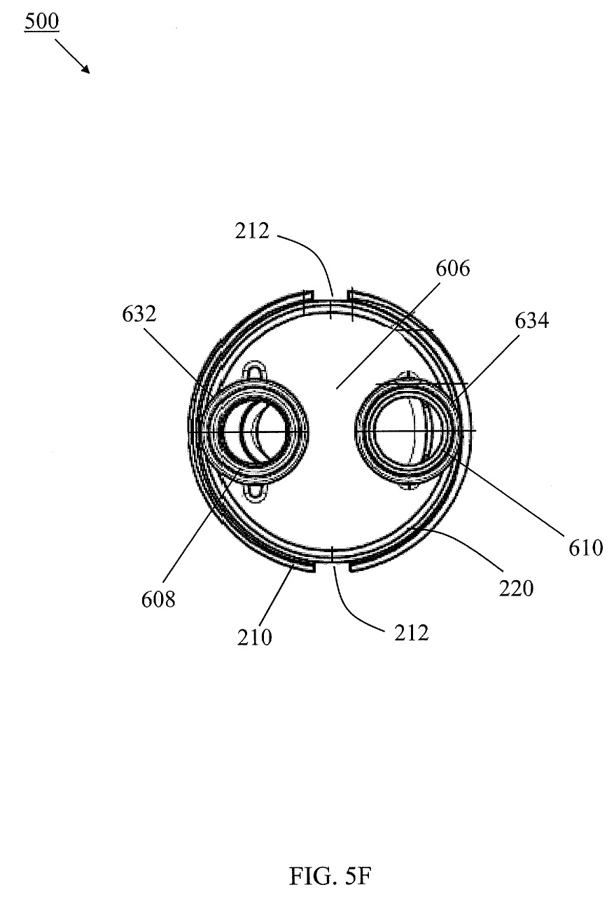

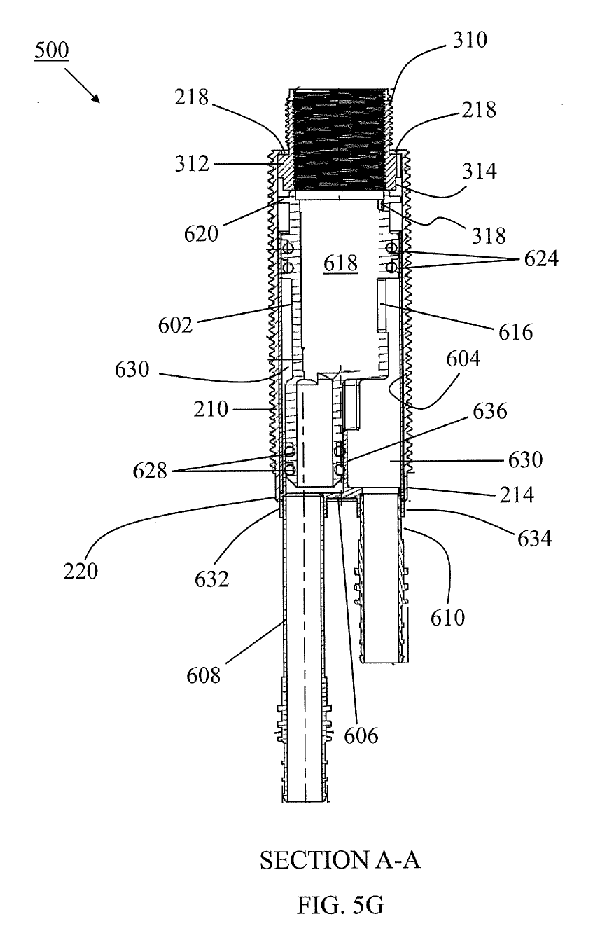

Referring to FIGS. 5A-5G, a hybrid valve body, according to a second exemplary embodiment, is shown as a multi-piece valve body assembly 500. The valve body assembly 500 has structure in common with the valve body assembly 100. In particular, the sleeve 200 and the upper body 300 of the valve assembly 500 are the same as in the valve body assembly 100. Accordingly, only the lower body 600 of the valve body assembly 500 will be described in detail.

The lower body 600 is an assembly including a number of components that are joined together to form an integral structure. In one exemplary embodiment, the components are joined together by brazing and friction fitting. More specifically, the lower body 600 includes a valve receptacle 602, a shell 604, a cover 606, an inlet conduit 608 and an outlet conduit 610 (see FIGS. 5B and 5G).

The valve receptacle 602 is a generally tubular body having a generally circular upper opening 612, a generally circular lower opening 614 and a side opening 616 (see FIG. 5B). The valve receptacle 602 is hollow and includes a generally cylindrical cavity 618 that extends between the upper opening 612 and the lower opening 614 (see FIG. 5G). A diameter of the valve receptacle 602 increases near the upper opening 612 to form an annular flange 620. A diameter of an inner surface of the sleeve 200 that defines the cavity 208 is approximately the same as a diameter of the annular flange 620 (see FIG. 5G).

The valve receptacle 602 includes a pair of circumferential grooves 622 that extend around an outer surface of the valve receptacle 602 between the upper opening 612 and the side opening 616. The grooves 622 are sized for receiving corresponding O-rings 624 therein. The valve receptacle 602 also includes a pair of circumferential grooves 626 that extend around an outer surface of the valve receptacle 602 between the lower opening 614 and the side opening 616. The grooves 626 are sized for receiving corresponding O-rings 628 therein.

The shell 604 is a generally tubular body having a generally circular upper opening and a generally circular lower opening. The shell 604 is hollow and includes a generally cylindrical cavity 630 that extends between the upper opening and the lower opening (see FIG. 5G).

The cover 606 is a generally disc-shaped body having a pair of apertures formed therein (see FIGS. 5B and 5F-5G). The apertures form an inlet port 632 and an outlet port 634 through the cover 606. The cover 606 is sized to close the lower opening of the shell 604. The inlet conduit 608 interfaces with the inlet port 632 of the cover 606 such that at least a portion of the inlet conduit 608 is located outside the shell 604 for connection to a water supply source (not shown). The outlet conduit 610 interfaces with the outlet port 634 such that at least a portion of the outlet conduit 610 is located outside the shell 604 for connection to a plumbing fixture or fitting (not shown). The cover 606 also includes a wall 636 that extends from a top of the cover 606 so as to be situated within the cavity 630 of the shell 604 when the cover 606 closes the lower opening of the shell 604 (see FIG. 5G). The wall 636 defines a chamber within the cavity 630.

The valve receptacle 602 is friction fit into the cavity 630 of the shell 604. As a result, the O-rings 624 are compressed against an inner surface of the shell 604, and the O-rings 628 are compressed against an inner surface of the chamber. The inlet conduit 608 and the outlet conduit 610 are brazed to the cover 606. The cover 606 is brazed to the shell 604 so that it closes the lower opening of the shell 604, thereby completing the lower body 600.

The valve body assembly 500 is assembled by inserting the upper body 300 through the lower opening 206 of the sleeve 200. The upper body 300 is then slid through the cavity 208 of the sleeve 200 toward the upper opening 204 of the sleeve 200. The upper portion 310 of the upper body 300 is sized to fit through the upper opening 204 of the sleeve 200, while the middle portion 312 of the upper body 300 is sized so that it does not fit through the upper opening 204 of the sleeve 200 (see FIG. 5G). In this manner, an upper surface of the middle portion 312 of the upper body 300 abuts a lower surface of the ledge 218 of the sleeve 200. Accordingly, the upper portion 310 of the upper body 300 projects out of the sleeve 200, while the middle portion 312 and lower portion 314 of the upper body 300 are located in the cavity 208 of the sleeve 200.

Thereafter, the lower body 600 is inserted through the lower opening 206 of the sleeve 200. The lower body 600 is then slid through the cavity 208 of the sleeve 200 toward the upper body 300. The lower body 600 is positioned in the cavity 208 of the sleeve 200 so that the lower body 600 interfaces with the upper body 300 within the sleeve 200 (see FIG. 5G). In one exemplary embodiment, at least a portion of the lower portion 314 of the upper body 300 is received in the annular flange 620 of the valve receptacle 602 of the lower body 600, during assembly of the valve body assembly 500.

Once the upper body 300 and the lower body 600 are inserted into the sleeve 200, the lip portion 214 of the sleeve 200 is deformed to secure the upper body 300 and the lower body 600 in the sleeve 200. Specifically, a portion 220 of the lip portion 214 is rolled over a portion of a lower surface of the cover 606 of the lower body 600 (see FIGS. 5C-5D and 5F-5G). The notches 216 in the lip portion 214 prevent the inlet port 632 and the outlet port 634 of the cover 606 from being damaged by the portion 220 of the lip portion 214 being rolled over the cover 606. In this manner, the upper body 300 and the lower body 600 are secured in the sleeve 200 between the ledge 218 and the portion 220 of the lip portion 214 (see FIGS. 5C-5D and 5G).

In one exemplary embodiment, the sleeve 200 is further deformed during assembly of the valve body assembly 500. Specifically, indents (not shown) are formed in the grooves 212 near the upper opening 204 of the sleeve 200. The indents project into the cavity 208 of the sleeve 200 and are positioned in spaces between the teeth 324 of the middle portion 312 of the upper body 300, thereby preventing rotation of the upper body 300 relative to the sleeve 200.

After assembly, the valve body assembly 500 can be installed by extending the valve body assembly 500 through a hole in a mounting surface. The grooves 212 on the valve body assembly 500 can interface with a mounting bracket to prevent rotation of the valve body assembly 500 relative to the mounting surface. A first retention nut can engage the outer threads 320 on the valve body assembly 500 on a first side of the mounting surface and a second retention nut can engage the threads 210 on the valve body assembly 500 on a second side of the mounting surface to secure the valve body assembly 500 to the mounting surface.

A first hose can connect the inlet conduit 608 of the valve body assembly 500 to the water supply source. A second hose can connect the outlet conduit 610 of the valve body assembly 500 to the plumbing fixture or fitting. The water inlet conduit 608, the valve receptacle 602, the side opening 616, the cavity 630 and the water outlet conduit 610 define a water flow path through the valve body assembly 500 (see FIG. 5G).

A valve member or cartridge can be placed in the valve receptacle 602 of the valve body assembly 500 to allow a user to control the flow rate of water from the water supply source, through the water flow path of the valve body assembly 500, to the plumbing fixture or fitting. The valve cartridge can include a projection or key sized to fit into the groove 318 of the upper body 300 to properly position the valve cartridge within the valve body assembly 500, thereby aligning the valve cartridge relative to the side opening 616 of the valve receptacle 602. A third retention nut can engage the inner threads 322 of the upper body 300 to secure the valve cartridge in the cavity 618 of the valve receptacle 602.

Because the valve body assembly 100 and the valve body assembly 500 (each more generally referred to as a hybrid valve body) are constructed from several discrete components, an amount of brass used in the hybrid valve body assembly can be reduced considerably. For example, one or more of the components can be made of a material other than brass. In one exemplary embodiment, the non-brass material is less expensive than brass, such that a materials cost associated with manufacturing the hybrid valve body is less than a materials cost associated with manufacturing a similar valve body made primarily or entirely of brass. In one exemplary embodiment, the non-brass material weighs less than brass, such that a weight of the hybrid valve body is less than a weight of a similar valve body made primarily or entirely of brass. In one exemplary embodiment, the non-brass material is unsuitable for use throughout the entire valve body.

In one exemplary embodiment, the valve body assembly 100 includes components made of a non-brass material (i.e., non-brass components) and components made of brass (i.e., brass components). The non-brass components and the brass components are held together in a manner that does not involve threading or otherwise fastening or moving the non-brass and brass components against one another in a manner which can compromise the surface properties (e.g., coating) of the non-brass and/or brass components. Accordingly, the non-brass components and the brass components are held together in a manner that reduces the likelihood of corrosion between the disparate materials.

According to one exemplary embodiment, the sleeve 200 and the upper body 300 of the valve body assembly 100 are made of a non-brass material. The non-brass material may be treated, coated or otherwise modified to have a brass-like appearance (e.g., color). In one exemplary embodiment, the non-brass material is aluminum.

As noted above, the lower body 400 (i.e., the water inlet conduit 408, the valve receptacle 402, the side opening 416, the cavity 426 and the water outlet conduit 410) of the valve body assembly 100 defines the water flow path. The lower body 400 is formed from brass. Because brass is strong, hard, easy to shape, a good conductor of heat and generally resistant to corrosion, brass is well-suited for forming the lower body 400 having the water flow path.

In this case, the sleeve 200 and the upper body 300 are the non-brass components and the lower body 400 is the brass component. The non-brass and brass components are not threaded or otherwise fastened or moved against one another in a manner which could contribute to corrosion between the components. Instead, the portion 220 of the lip portion 214 rolled over the cover 406 of the lower body 400 secures the upper body 300 and the lower body 400 in the sleeve 200.

In one exemplary embodiment, between 35% and 45% by volume of the valve body assembly 100 is brass. In one exemplary embodiment, approximately 40.2% by volume of the valve body assembly 100 is brass.

In one exemplary embodiment, between 62% and 72% by weight of the valve body assembly 100 is brass. In one exemplary embodiment, approximately 67.3% by weight of the valve body assembly 100 is brass.

In one exemplary embodiment, the valve body assembly 100 realizes a reduction between 50% and 80% by volume in brass as compared to an identical valve body assembly made entirely of brass. In one exemplary embodiment, the valve body assembly 100 realizes a reduction between 57% and 67% by volume in brass as compared to a similar valve body assembly made entirely of brass. In one exemplary embodiment, the valve body assembly 100 realizes a reduction of approximately 61.5% by volume in brass as compared to an identical valve body assembly made entirely of brass.

In one exemplary embodiment, the valve body assembly 100 realizes a reduction between 50% and 80% by weight in brass as compared to an identical valve body assembly made entirely of brass. In one exemplary embodiment, the valve body assembly 100 realizes a reduction between 55% and 65% by weight in brass as compared to a similar valve body assembly made entirely of brass. In one exemplary embodiment, the valve body assembly 100 realizes a reduction of approximately 60.0% by weight in brass as compared to an identical valve body assembly made entirely of brass.

In one exemplary embodiment, the valve body assembly 100 includes brass and non-brass material. In one exemplary embodiment, the valve body assembly 100 has a brass content measured as a volume of brass in the valve body assembly 100 and a non-brass content measured as a volume of non-brass material in the valve body assembly 100, and a ratio of the brass content to the non-brass content is less than or equal to 0.673.

In one exemplary embodiment, the valve body assembly 100 includes brass and non-brass material. In one exemplary embodiment, the valve body assembly 100 has a brass content measured as a weight of brass in the valve body assembly 100 and a non-brass content measured as a weight of non-brass material in the valve body assembly 100, and a ratio of the brass content to the non-brass content is less than or equal to 2.058.

In one exemplary embodiment, the valve body assembly 100 includes brass and non-brass material. In one exemplary embodiment, the valve body assembly 100 has a brass content measured as a volume of brass in the valve body assembly 100 and a non-brass content measured as a volume of non-brass material in the valve body assembly 100, and the brass content is less than the non-brass content.

In one exemplary embodiment, the valve body assembly 500 includes components made of a non-brass material (i.e., non-brass components) and components made partially of brass (i.e., partial brass components). The non-brass components and the partial brass components are held together in a manner that does not involve threading or otherwise fastening or moving the non-brass and partial brass components against one another in a manner which can compromise the surface properties (e.g., coating) of the non-brass and/or partial brass components. Accordingly, the non-brass components and the partial brass components are held together in a manner that reduces the likelihood of corrosion between the disparate materials.

According to one exemplary embodiment, the sleeve 200 and the upper body 300 of the valve body assembly 500 are made of a non-brass material. The non-brass material may be treated, coated or otherwise modified to have a brass-like appearance (e.g., color). In one exemplary embodiment, the non-brass material is aluminum.

As noted above, the lower body 600 (i.e., the water inlet conduit 608, the valve receptacle 602, the side opening 616, the cavity 630 and the water outlet conduit 610) of the valve body assembly 500 defines the water flow path. The lower body 600 is formed at least partially from brass. Because brass is strong, hard, easy to shape, a good conductor of heat and generally resistant to corrosion, brass is well-suited for forming the lower body 600 having the water flow path.

To realize a further reduction in the brass content of the valve body assembly 500, at least a portion of the lower body 600 is formed from a non-brass material. In one exemplary embodiment, the valve receptacle 602 of the lower body 600 is made of plastic. As a non-brass piece of the lower body 600, the valve receptacle 602 is held together with the brass pieces of the lower body 600 (i.e., the shell 604, the cover 606, the inlet conduit 608 and the outlet conduit 610) in a manner that does not involve threading or otherwise fastening or moving the non-brass piece and the brass pieces together in a manner which could compromise the surface properties (e.g., coating) of the non-brass and/or brass pieces. Accordingly, the non-brass piece and the brass pieces are held together in a manner that reduces the likelihood of corrosion between the disparate materials.

Thus, the sleeve 200 and the upper body 300 are the non-brass components and the lower body 600 is the partial brass component of the valve body assembly 500. As noted above, the non-brass and partial brass components are not threaded or otherwise fastened or moved against one another in a manner which could contribute to corrosion between the components. Instead, the portion 220 of the lip portion 214 rolled over the cover 606 of the lower body 600 secures the upper body 300 and the lower body 600 in the sleeve 200.

In one exemplary embodiment, between 20% and 30% by volume of the valve body assembly 500 is brass. In one exemplary embodiment, approximately 24.7% by volume of the valve body assembly 500 is brass.

In one exemplary embodiment, between 51% and 61% by weight of the valve body assembly 500 is brass. In one exemplary embodiment, approximately 55.6% by weight of the valve body assembly 500 is brass.

In one exemplary embodiment, the valve body assembly 500 realizes a reduction between 50% and 80% by volume in brass as compared to an identical valve body assembly made entirely of brass. In one exemplary embodiment, the valve body assembly 500 realizes a reduction between 62% and 72% by volume in brass as compared to a similar valve body assembly made entirely of brass. In one exemplary embodiment, the valve body assembly 500 realizes a reduction of approximately 67.4% by volume in brass as compared to an identical valve body assembly made entirely of brass.

In one exemplary embodiment, the valve body assembly 500 realizes a reduction between 50% and 80% by weight in brass as compared to an identical valve body assembly made entirely of brass. In one exemplary embodiment, the valve body assembly 500 realizes a reduction between 62% and 72% by weight in brass as compared to a similar valve body assembly made entirely of brass. In one exemplary embodiment, the valve body assembly 500 realizes a reduction of approximately 66.9% by weight in brass as compared to an identical valve body assembly made entirely of brass.

In one exemplary embodiment, the valve body assembly 500 includes brass and non-brass material. In one exemplary embodiment, the valve body assembly 500 has a brass content measured as a volume of brass in the valve body assembly 500 and a non-brass content measured as a volume of non-brass material in the valve body assembly 500, and a ratio of the brass content to the non-brass content is less than or equal to 0.327.

In one exemplary embodiment, the valve body assembly 500 includes brass and non-brass material. In one exemplary embodiment, the valve body assembly 500 has a brass content measured as a weight of brass in the valve body assembly 500 and a non-brass content measured as a weight of non-brass material in the valve body assembly 500, and a ratio of the brass content to the non-brass content is less than or equal to 1.250.

In one exemplary embodiment, the valve body assembly 500 includes brass and non-brass material. In one exemplary embodiment, the valve body assembly 500 has a brass content measured as a volume of brass in the valve body assembly 500 and a non-brass content measured as a volume of non-brass material in the valve body assembly 500, and the brass content is less than the non-brass content.

In one exemplary embodiment, 15% to 50% by volume of a valve body assembly (e.g., the valve body assembly 100, the valve body assembly 500) is brass. In one exemplary embodiment, 45% to 80% by weight of a valve body assembly (e.g., the valve body assembly 100, the valve body assembly 500) is brass.

The above description of specific embodiments has been given by way of example. From the disclosure given, those skilled in the art will not only understand the general inventive concept and its attendant advantages, but will also find apparent various changes and modifications to the structures and methods disclosed. It is sought, therefore, to cover all such changes and modifications as fall within the spirit and scope of the general inventive concept, as defined by the appended claims, and equivalents thereof.

What is claimed is:

1. A valve body assembly comprising:
an upper body having a first cavity;
a lower body having a second cavity and including a water inlet passage and a water outlet passage in fluid communication with the second cavity; and
a sleeve having a third cavity,
wherein the second cavity is operable to house a valve member to control the flow of water from the water inlet passage to the water outlet passage,
wherein the first cavity is operable to allow an actuating mechanism to interface with the valve member,
wherein at least a portion of the upper body and at least a portion of the lower body are disposed in the third cavity,
wherein deformation of the sleeve retains the upper body and the lower body in the third cavity.

2. The valve body assembly of claim 1, wherein the upper body contains no brass,
wherein the lower body contains brass, and
wherein the sleeve contains no brass.

3. The valve body assembly of claim 1, wherein the upper body is made entirely of aluminum,
wherein the lower body is made entirely of brass, and
wherein the sleeve is made entirely of aluminum.

4. The valve body assembly of claim 1, wherein the upper body contains no brass,
wherein the lower body contains brass and a non-brass material, and
wherein the sleeve contains no brass.

5. The valve body assembly of claim 1, wherein the upper body is made entirely of aluminum,
wherein the lower body includes brass and a non-brass material, and
wherein the sleeve is made entirely of aluminum.

6. The valve body assembly of claim 1, wherein between 15% and 50% by volume of the valve body assembly is brass.

7. The valve body assembly of claim 1, wherein between 45% and 80% by weight of the valve body assembly is brass.

8. The valve body assembly of claim 1, wherein the valve body assembly realizes a reduction between 50% and 80% by volume in brass as compared to a similar valve body assembly made entirely of brass.

9. The valve body assembly of claim 1, wherein the valve body assembly realizes a reduction between 50% and 80% by weight in brass as compared to a similar valve body assembly made entirely of brass.

10. The valve body assembly of claim 1, wherein the valve body assembly includes brass and non-brass material,
wherein the valve body has a brass content measured as a volume of the brass in the valve body assembly and a non-brass content measured as a volume of the non-brass material in the valve body assembly, and
wherein a ratio of the brass content to the non-brass content is less than or equal to 0.673.

11. The valve body assembly of claim 1, wherein the valve body assembly includes brass and non-brass material,
wherein the valve body assembly has a brass content measured as a volume of the brass in the valve body assembly and a non-brass content measured as a volume of the non-brass material in the valve body assembly, and
wherein a ratio of the brass content to the non-brass content is less than or equal to 0.327.

12. The valve body assembly of claim 1, wherein the valve body assembly includes brass and non-brass material,
wherein the valve body assembly has a brass content measured as a weight of the brass in the valve body assembly and a non-brass content measured as a weight of the non-brass material in the valve body assembly, and
wherein a ratio of the brass content to the non-brass content is less than or equal to 2.058.

13. The valve body assembly of claim 1, wherein the valve body assembly includes brass and non-brass material,
wherein the valve body assembly has a brass content measured as a weight of the brass in the valve body assembly and a non-brass content measured as a weight of the non-brass material in the valve body assembly, and
wherein a ratio of the brass content to the non-brass content is less than or equal to 1.250.

14. The valve body assembly of claim 1, wherein the valve body assembly includes brass and non-brass material,
wherein the valve body assembly has a brass content measured as a volume of the brass in the valve body assembly and a non-brass content measured as a volume of the non-brass material in the valve body assembly, and
wherein the brass content is less than the non-brass content.

15. The valve body assembly of claim 1, wherein the sleeve includes a lip portion, and
wherein the lip portion is rolled over a portion of the lower body to fix the upper body relative to the lower body.

16. A three-piece valve body comprising:
a first member;
a second member; and
a third member,
wherein the second member includes a water inlet passage and a water outlet passage that form a water flow path through the valve body,
wherein the second member includes a cavity formed between the water inlet passage and the water outlet passage, the cavity being operable to receive a valve member for controlling the flow rate of water along the water flow path,
wherein the first member includes an opening that is operable to allow an actuating member to interface with a valve member in the cavity of the second member,
wherein the third member surrounds at least a portion of the first member and at least a portion of the second member, and
wherein the third member is deformed to prevent axial displacement of the first member relative to the second member.

17. The three-piece valve body of claim 16, wherein the first member contains no brass,
wherein the second member contains brass, and
wherein the third member contains no brass.

18. The three-piece valve body of claim 17, wherein the first member is made entirely of aluminum,
wherein the second member is made entirely of brass, and
wherein the third member is made entirely of aluminum.

19. The three-piece valve body of claim 16, wherein the first member contains no brass,
wherein the second member contains brass and a non-brass material, and
wherein the third member contains no brass.

20. The three-piece valve body of claim 19, wherein the first member is made entirely of aluminum, and
wherein the third member is made entirely of aluminum.
